(19) United States
(12) Patent Application Publication
(10) Pub. No.: US 2016/0247366 A1
(43) Pub. Date: Aug. 25, 2016

(54) ENHANCED A-FRAME WARNING SIGN WITH INTEGRAL CAUTION LIGHTS AND AUDIBLE WARNING

(71) Applicants: William Munoz, Chicago, IL (US); Elisa A. Alfaro, Chicago, IL (US)

(72) Inventors: William Munoz, Chicago, IL (US); Elisa A. Alfaro, Chicago, IL (US)

(21) Appl. No.: 14/625,633

(22) Filed: Feb. 19, 2015

(51) Int. Cl. G08B 5/36

(52) U.S. Cl. CPC G08B 5/36

(57) ABSTRACT

A portable warning sign, warning light, and audible warning system, based on a foldable A-frame stand, has a warning message carried on one or both opposite faces of the stand and warning lights at the top thereof for attracting attention to the message. The warning lights, as LEDs, are battery- or solar-powered and are preferably rechargeable. A motion sensor and speaker for giving an audible warning of the danger to actual passers-by may also be included.

This application claims the benefit of the priority of a corresponding provisional application for U.S. Pat. No. 6,194,2510, filed Feb. 20, 2014.

### FIELD OF THE INVENTION

The present invention relates to portable, A-frame type warning signs for construction, servicing, hazard warning, and such.

### BACKGROUND OF THE ART

Portable A-frame signs are well known, for placing on a floor, road, or sidewalk where attention should be given to a dangerous or unusual situation that demands special or heightened attention from passers-by. Such signs are typically light- and brightly-colored, as in orange and white stripes, and may carry a circular, flashing strobe light atop their structure or within their borders; lights may be battery- or solar-powered. They are single-purpose, as with “WET FLOOR” or “FALLING ICE” inscribed boldly on them. Published patent application US 2009/0158628 A1 is one example.

No product is known in which a portable A-frame sign has integral, rechargeable lighting to provide to passersby an active warning tailored to the situation at hand.

### SUMMARY OF THE INVENTION

An object of the present invention is to provide an active, highly visible and/or noticeable warning of a specific danger at or near a location where the danger exists. The warning may be visual and/or audible, either continuously or motion-sensor activated.

A light-weight but sturdy, foldable, A-frame structure as of molded plastic is provided with a flat, inclined surface on both of its sides for a selected warning message thereon. A flashing light bar, as with light-emitting diodes, a power source, and an on-off switch, and/or an audible warning system including a message chip and a speaker and power source, gives active warning of the presence of the sign and its message. The power source can be batteries, solar cells, or a combination thereof; the batteries are preferably rechargeable separately from the solar cells.

### BRIEF DESCRIPTION OF THE DRAWINGS

FIG. 1 is a plan view of one face of a portable A-frame warning sign stand with space thereon for a sign and with a bi-directional warning light atop the frame, and an optional motion sensor, speaker, and voice chip. The opposite side is similar.

FIG. 2 is an enlarged plan view of a light bar that is adapted to be affixed to the top of the portable A-frame warning sign of FIG. 1, with the lights visible from both sides of the sign.

### THE PREFERRED EMBODIMENTS

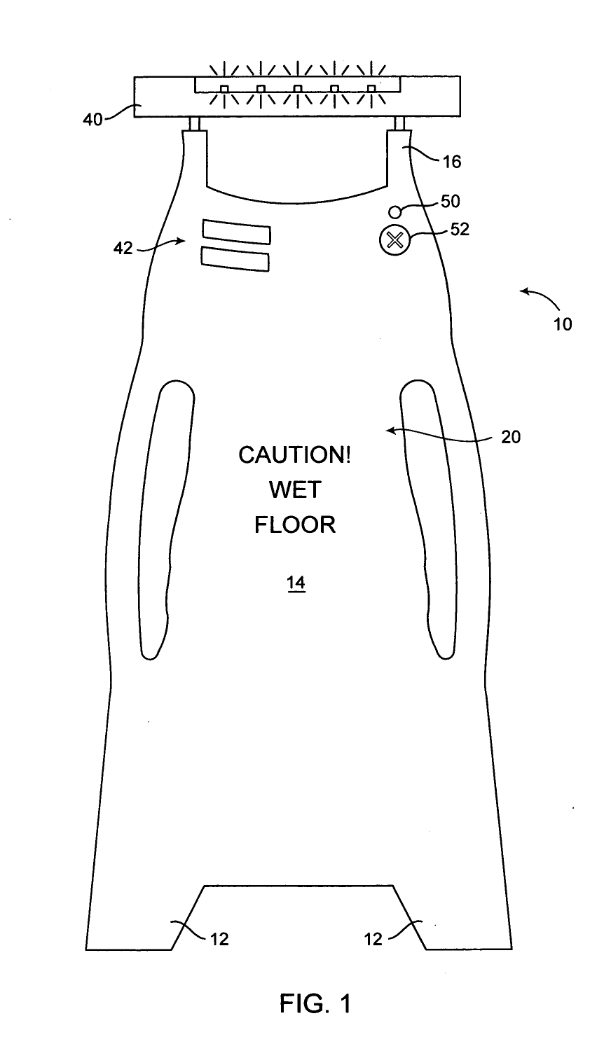

One face of a blow-molded or similar plastic or fiberglass A-frame sign holder is shown at 10 in FIG. 1. It has feet 12, a sign face 14, and an upper hinge area 16. An opposite side or face (not shown) is normally identical but can vary in detail, cooperating with the first side or face to form a stable construction when unfolded, as is well known in the art.

In accordance with principles of the invention, sign face 14 is adapted to bear any of a number of warning messages 20. The message 20, may be such as WET FLOOR, FALLING ICE, UNEVEN SURFACE, HAZARDOUS CHEMICALS, or such. Permanent painting or printing on the surface of the sign is desirable.

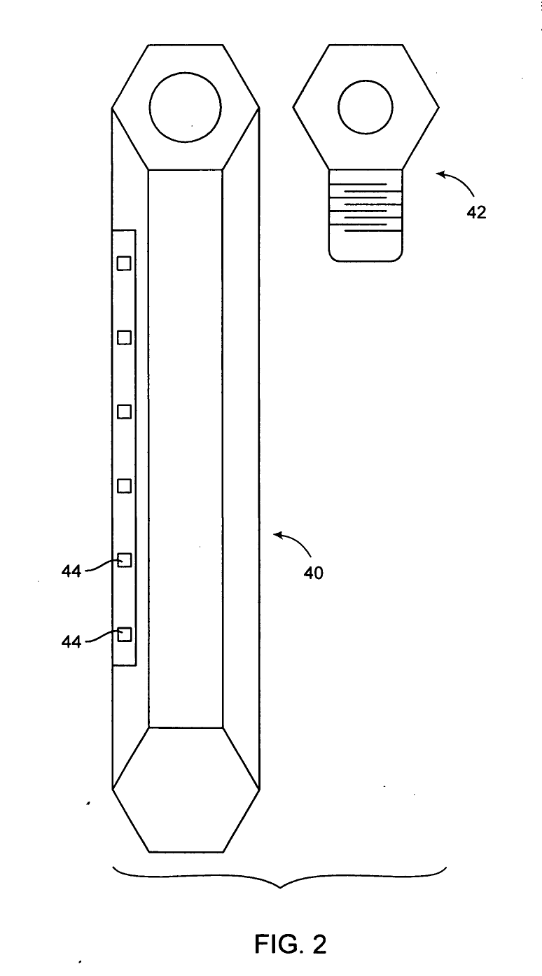

In further accordance with the invention, as in FIG. 2, an illuminated, continuously on or flashing light bar 40 is affixed atop the A-frame device 10. It may be part of the assembly, as acting as a hinge, or it may be affixed atop the A-frame, above the hinge area, as in FIG. 1. LEDs or other efficient, low-voltage lights of suitable brightness 44 are provided atop the light bar 40 to call passersbys' attention, from either direction of approach to the sign 20, and thus to give added warning of the dangerous condition being advised of Three or five or more such lights 44 are preferably provided in a row or two atop the sign 10 from which pedestrians or other traffic approach the sign 20

The light bar 40 encloses rechargeable batteries (not shown) of sufficient capacity to last a day or night or more, to keep the lights 44 on or flashing, as may be desired. Recharging can be done on a separate stand, not shown, during storage of a number of the light bars 40. In an alternative arrangement, solar cells 42 can be added to the sign 10 or to the assembly 40 to power the lights and/or to charge the batteries during times of daylight. A light-sensitive and/or manual switch (not shown) can be provided on the light bar 40 to turn off the lights 44 for times of shipment and storage of the light bar 40 and associated sign 10. The switch may also govern continuous on or off or one or more flashing modes of the lights 44.

Also in accordance with principles of the invention, an audible warning is preferably provided by the sign 10, either together with or separately from the visual, flashing lights warning. Preferably a motion sensor 50 is provided on each side of the sign 10, which is triggered by a person's approach within ten or twenty feet, for instance, of the sign. The sensor 50 activates a voice chip (not shown) carried in the sign 10, which operates a speaker 52 on the face of the sign to give a repeated audible warning, as “Caution: Wet Floor! Caution: Wet Floor!” or the like.

Many variations may be made in the invention as shown and its manner of use without departing from the principles of the invention as pictured and described herein and claimed as our invention. Minor variations will not avoid the use of the invention.

The invention claimed is:

1. A portable warning sign system comprising:
a foldable A-frame stand having at least one sign face;
a warning message on at least one face of the sign for warning of a hazard in the vicinity; and
a selectively illuminated light bar atop said A-frame stand for use in attracting the attention of persons approaching the stand, the light bar having one or more lights visible in the direction of persons approaching the sign system.

2. The portable warning sign system as defined in claim 1, wherein the light bar comprises LEDs and a battery system.

3. The portable warning sign system as defined in claim 2, wherein the battery system includes a recharging system using power from at least one solar cell.

4. The portable warning sign system as defined in claim 2, wherein the battery system consists of rechargeable batteries.

5. The portable warning sign system as defined in claim 4, further comprising an audible warning system comprising a motion sensor, a speaker, and a means of generating a voice warning of the condition nearby that is the subject of the warning sign.
